(19) United States
(12) Patent Application Publication
(10) Pub. No.: US 2004/0090406 A1
(43) Pub. Date: May 13, 2004

(54) Liquid crystal display

(75) Inventors: Ming-Tien Lin, Taipei Hsien (TW); Te-Cheng Chung, Taoyuan Hsien (TW); Tean-Sen Jen, Taoyuan Hsien (TW)

Correspondence Address: OBLON, SPIVAK, MCCLELLAND, MAIER & NEUSTADT, P.C., 1940 DUKE STREET, ALEXANDRIA, VA, 22314, US

(73) Assignee: HANNSTAR DISPLAY CORPORATION, Taipei (CN)

(21) Appl. No.: 10/696,463

(22) Filed: Oct. 30, 2003

(30) Foreign Application Priority Data
Nov. 12, 2002 (TW) 091133188

(51) Int. Cl. G09G 3/36

(52) U.S. Cl. 345/87

(57) ABSTRACT

A liquid crystal display has a pixel area defined by a pair of transverse-extending gate lines and a pair of lengthwise-extending data lines. A pixel electrode is formed overlying the pixel area, and a switching element is electrically connected to the pixel electrode. At least one floating BM shielding layer is formed between the two gate lines and parallel to the data line. The floating BM shielding layer is electrically connected to one of the two gate lines.

### RELATED APPLICATIONS

This application claims the benefit of the filing date of Taiwanese Application Serial No. 091/33188, filed Nov. 12, 2002, the contents of which are incorporated by reference herein.

### BACKGROUND OF THE INVENTION

1. Field of the Invention

The invention relates to an electrode array design for a TFT-LCD device, and more particularly to a floating black matrix (BM) serving as a light-shielding element and integrated into a TFT array substrate. A connection design between the floating BM to a gate line provides an increased aperture ratio of the TFT-LCD device, a reduced coupling effect between a data line and a pixel electrode, a complementary storage capacitor and an operative path for repairing an opened gate line.

2. Description of the Related Art

Liquid crystal display (LCD) devices are a well-known form of flat panel display with advantages of low power consumption, light weight, thin profile, and low driving voltage. Liquid crystal molecules change their orientations and photo-electronic effects when an electronic field is applied. In the display region of the LCD, an array of pixel regions is patterned by horizontally extended gate lines and vertically extended data lines. For a TFT-LCD device, each pixel region has a thin film transistor (TFT) and a pixel electrode, in which the TFT serves as a switching device. Generally, the limitations in LCD mode causes insufficient transparency, thus a backlight source or an electrode array design for increasing aperture ratio should be provided to improve the transparency of the TFT-LCD device. The conventional electrode array design for the TFT-LCD device, however, has the disadvantage of unsatisfactory aperture ratio.

Recently, various designs for the electrode array in the TFT-LCD device have been developed to achieve a higher aperture ratio. For example, U.S. Pat. No. 5,339,181 discloses a bottom electrode of a storage capacitor which surrounds a marginal edge portion of an associated pixel electrode to serve as a shielding electrode. In another advanced technology, a floating black matrix (BM) serving as a light-shielding element is integrated into a TFT array substrate to overcome low aperture ratio.

FIG. 1A is an equivalent circuit diagram showing a conventional electrode array of a TFT-LCD device. A TFT-LCD device 10 comprises a pixel array constituting a plurality of pixel electrodes and a switching element array constituting a plurality of TFTs 18a and 18b. For example, in a pixel area Ra defined by two adjacent gate lines 12a and 12b and two adjacent data lines 14a and 14b, the TFT 18a serving as a switching device is connected to the data line 14a and a pixel electrode formed within the pixel area Ra. The two adjacent gate lines 12a and 12b are used as scanning electrodes, and the two adjacent data lines 14a and 14b are used as video signal electrodes.

Theoretically, an external voltage applied to the liquid crystal (LC) in the above-described electrode array is retained by a pixel capacitor CL (also called LC capacitor) formed on the pixel electrode. However, in practice, a voltage variation is found in the periphery of the pixel electrode to generate a coupling effect through a parasitic capacitor, resulting in a change in the voltage applied to LC. Thus, in order to improve charge storage and reduce the voltage coupling effect, a storage capacitor Cs is further provided in the pixel area.

FIG. 1B is a layout diagram showing a conventional electrode array with a floating BM as a light-shielding element in a TFT-LCD device. A pixel area Ra is defined by two traverse-extending gate lines 12a and 12b and two lengthwise-extending data lines 14a and 14b, and a pixel electrode 16 is formed thereon. Also, in order to increase a transparent area in the pixel area Ra, a TFT 18a and a storage capacitor 20a are formed over the gate line 12a, and a TFT 18b and a storage capacitor 20b are formed over the gate line 12b. Moreover, in order to shield a light leakage area in the periphery of the two data lines 14a and 14b, a first floating BM shielding layer 22A is formed parallel to the data line 14a and adjacent to the periphery of the pixel electrode 16 and the data line 14a without connecting to the two gate lines 12a and 12b, and a second floating BM shielding layer 22B is formed parallel to the data line 14b and adjacent to the periphery of the pixel electrode 16 and the data line 14b without connecting to the two gate lines 12a and 12b.

FIG. 2 is a sectional diagram along line I-I shown in FIG. 11B. On a substrate 24, a gate insulating layer 26 is sandwiched between floating BM shielding layers 22A and 22B and the pixel electrode 16, and the pixel electrode 16 partially overlaps floating BM shielding layers 22A and 22B.

A process for manufacturing the electrode array in the TFT-LCD device 10 is described with reference to FIG. 1B and FIG. 2. Using deposition, photolithography, and etching, a first metal layer is patterned on the glass substrate 24 to serve as gate lines 12a and 12b and floating BM shielding layers 22A and 22B. Particularly, two first predetermined areas (of a plurality) of the two gate lines 12a and 12b serve as two bottom electrodes of the two storage capacitors 20a and 20b, respectively. Then, the gate insulating layer 26 is deposited to cover the entire surface of the glass substrate 24. Next, TFT processes are performed on two second predetermined areas (of a plurality) of the gate lines 12a and 12b to complete the two TFTs 18a and 18b, respectively. Next, using deposition, photolithography, and etching, a second metal layer is patterned on the glass substrate 24 to serve as data lines 14a and 14b and source/drain electrodes of the two TFTs 18a and 18b. Finally, using deposition, photolithography, and etching, a transparent conductive layer is patterned on the glass substrate 24 to serve as the pixel electrode 16 and two upper electrodes of the two storage capacitors 20a and 20b.

Floating BM shielding layer 22A shields a light leakage area between the data line 14a and the periphery of the pixel electrode 16, and floating BM shielding layer 22B shields a light leakage area between the data line 14b and the periphery of the pixel electrode 16, thus the TFT-LCD device 10 has a higher aperture ratio in order to present superior contrast. The individual formation of floating BM shielding layers 22A and 22B, however, has a higher process cost, and the increase in aperture ratio attained by floating BM shielding layers 22A and 22B has been inadequate in meeting product demands for higher ppi (pixel per inch) value. Furthermore, as shown by the two arrows in FIG. 2, a coupling problem exists between the data lines 14a and 14b and the pixel electrode 16. Moreover, if line defects are found in the gate line 12a or 12b, the electrode array in the TFT-LCD device 10 can not provide a facile and operative path for repairing an opened gate line.

### SUMMARY OF THE INVENTION

Accordingly, an object of the invention is to provide an electrode array design for a TFT-LCD device, in which a floating BM shielding layer serves as a light-shielding element and is integrated into a TFT array substrate. A connection design between a floating BM shielding layer to a gate line provides an increased aperture ratio of the TFT-LCD device, a reduced coupling effect between a data line and a pixel electrode, a complementary storage capacitor, and an operative path for repairing an opened gate line.

To achieve these and other advantages, the invention provides a liquid crystal display which has a pixel area defined by a pair of transverse-extending gate lines and a pair of lengthwise-extending data lines. A pixel electrode is formed overlying the pixel area, and a switching element is electrically connected to the pixel electrode. At least one floating BM shielding layer is formed between the two gate lines and parallel to the data line. Floating BM shielding layer is electrically connected to one of the two gate lines.

### BRIEF DESCRIPTION OF THE DRAWINGS

For a better understanding of the present invention, reference is made to a detailed description thereof to be read in conjunction with the accompanying drawings, in which:

FIG. 1A is an equivalent circuit diagram showing a conventional electrode array of a TFT-LCD device;

FIG. 1B is a layout diagram showing a conventional electrode array with a floating BM as a light-shielding element in a TFT-LCD device;

FIG. 2 is a sectional diagram along line I-I shown in FIG. 1B;

FIG. 3A is a plane view showing a pixel area of an LCD device with a high aperture ratio according to the first embodiment of the present invention;

FIGS. 3B to 3D are plane views showing a method of forming the electrode array in the TFT-LCD device shown in FIG. 3E;

FIG. 3E is a plane view showing a TFT-LCD device with a floating BM shielding layer as a light-shielding element according to the first embodiment of the present invention;

FIG. 4 is a sectional diagram along line II-II shown in FIG. 3E;

FIG. 5 is a plane view showing an electrode array for repairing gate lines according to the second embodiment of the present invention;

FIG. 6 is a plane view showing a TFT-LCD device with a floating BM shielding layer as a light-shielding element according to the third embodiment of the present invention;

FIG. 7 is a sectional diagram along line III-III shown in FIG. 6 to show LC molecule orientations; and

FIG. 8 is a plane view showing a TFT-LCD device with a floating BM shielding layer as a light-shielding element according to the fourth embodiment of the present invention.

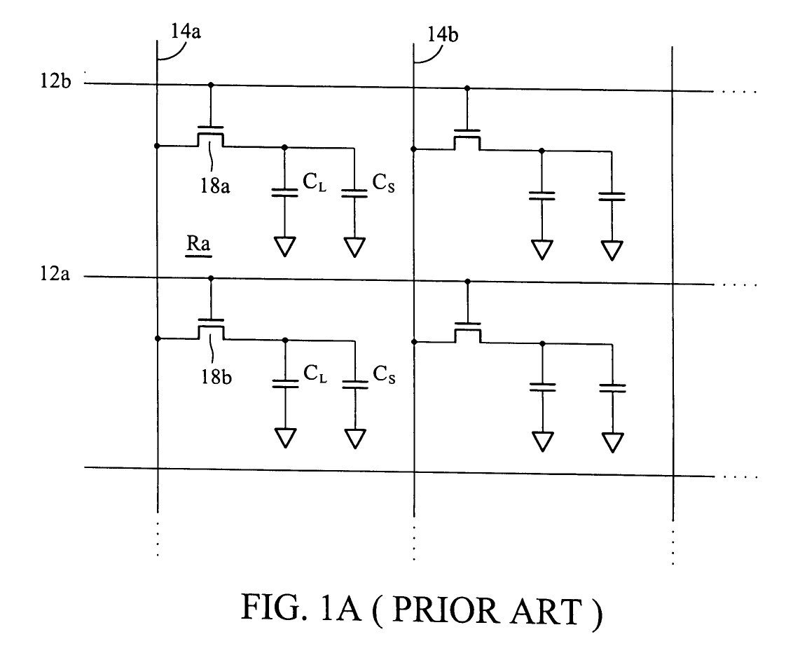

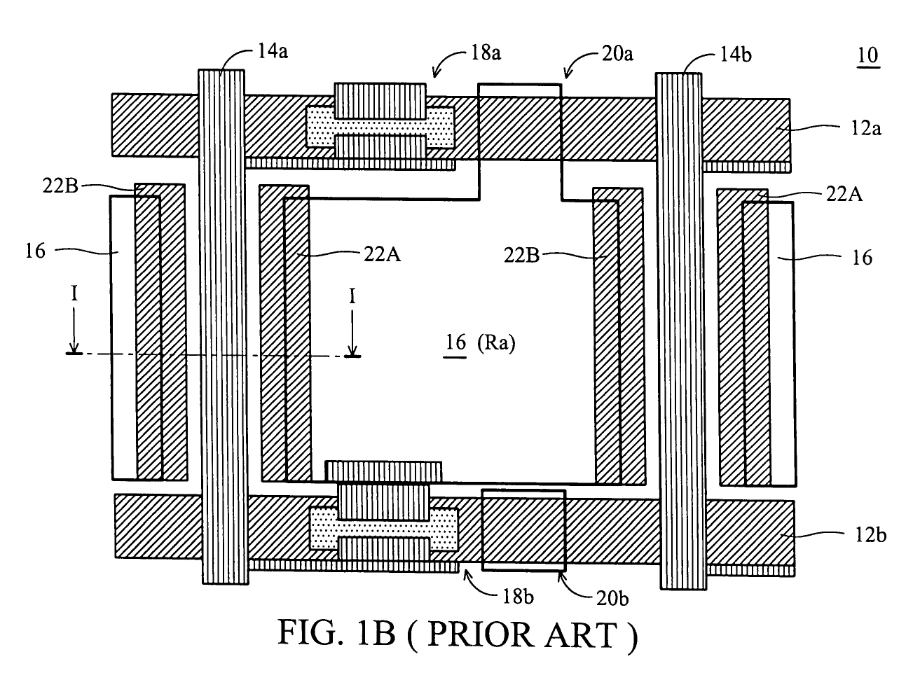

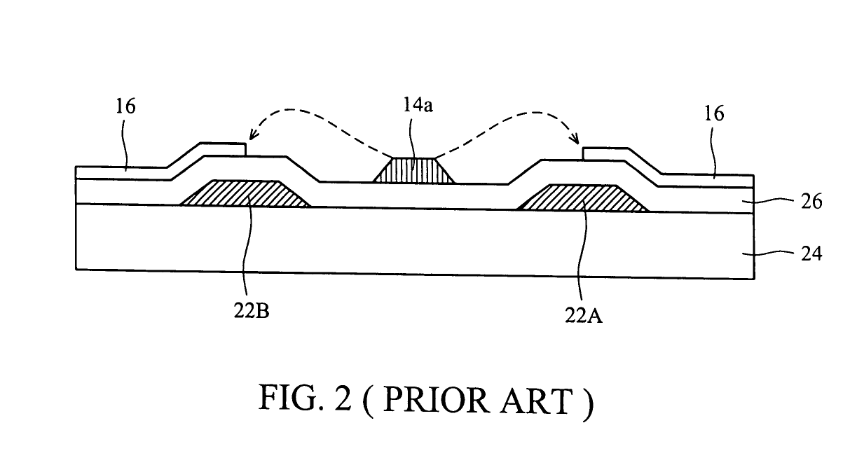

### DETAILED DESCRIPTION OF THE PREFERRED EMBODIMENTS

First Embodiment

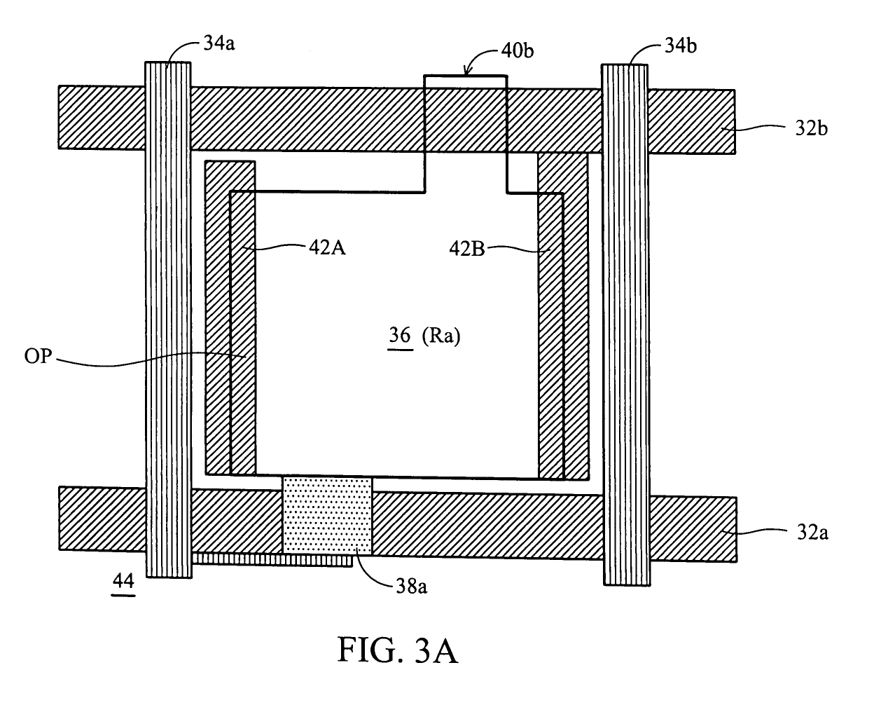

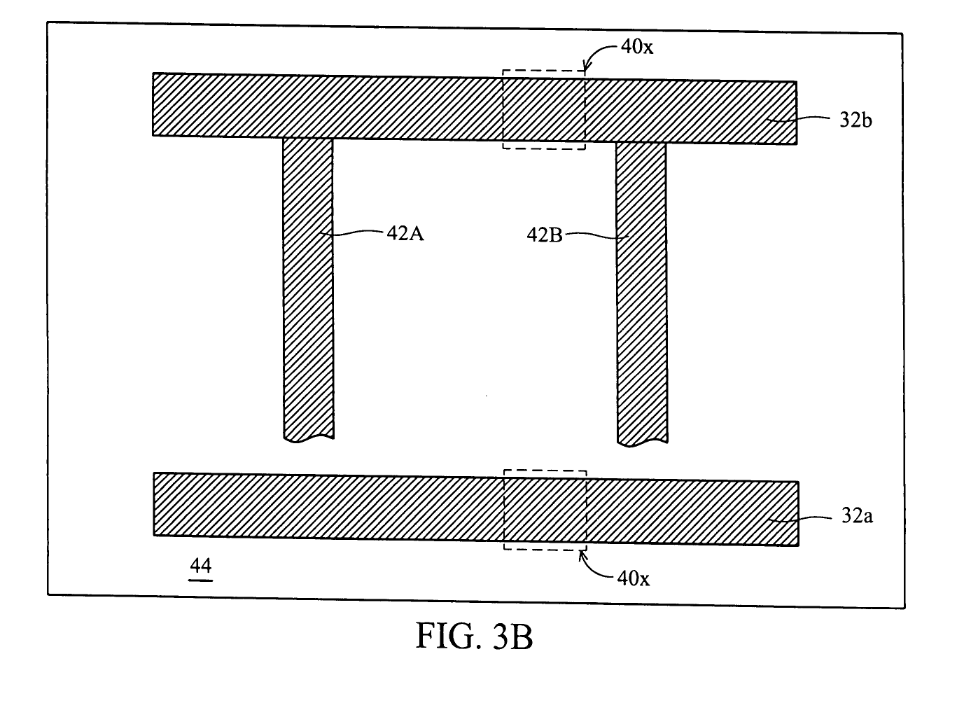

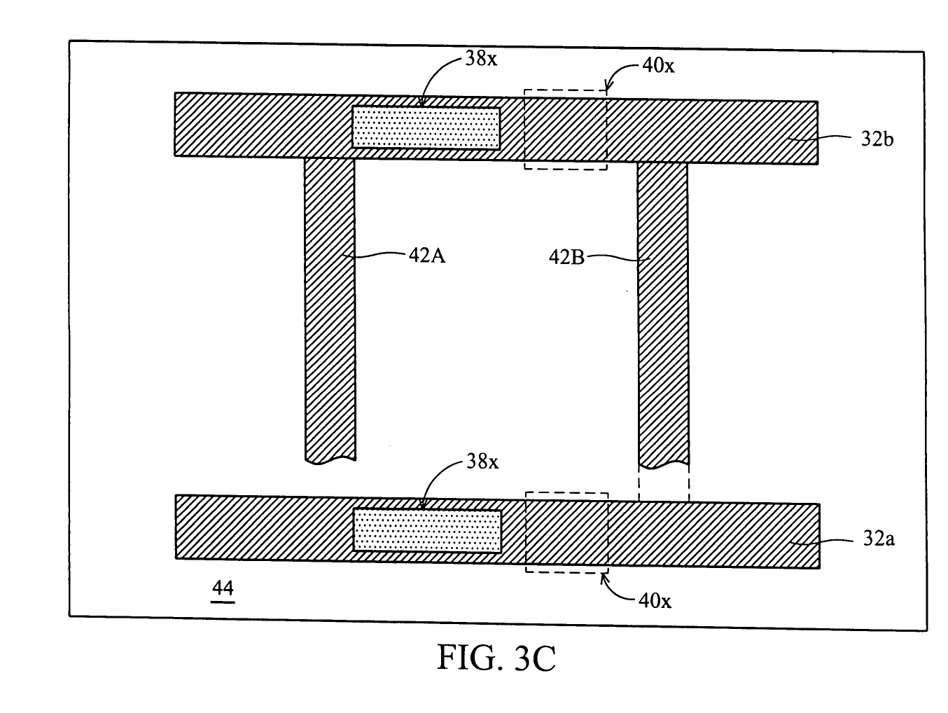

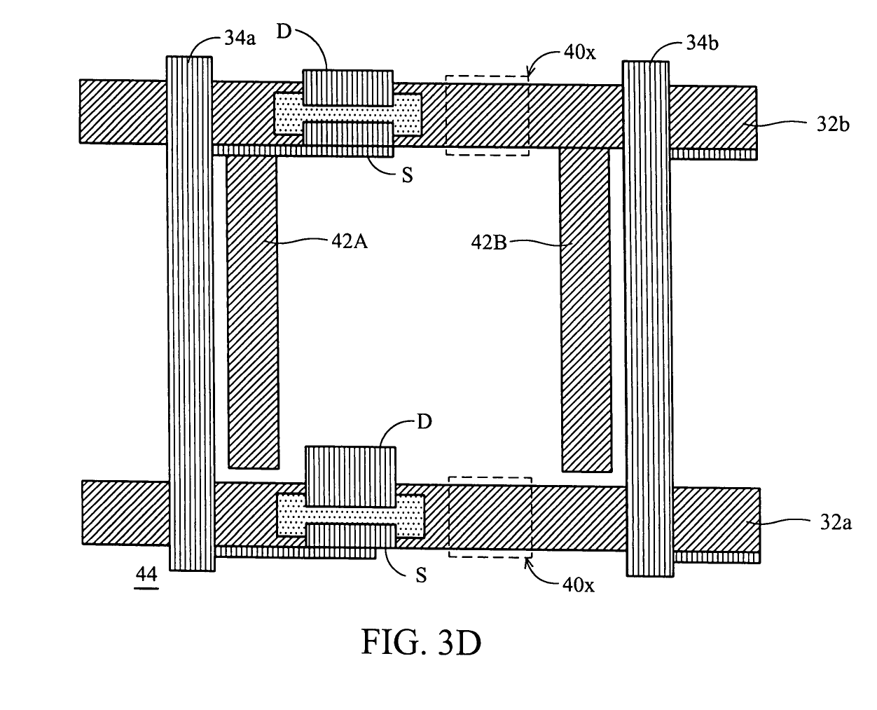

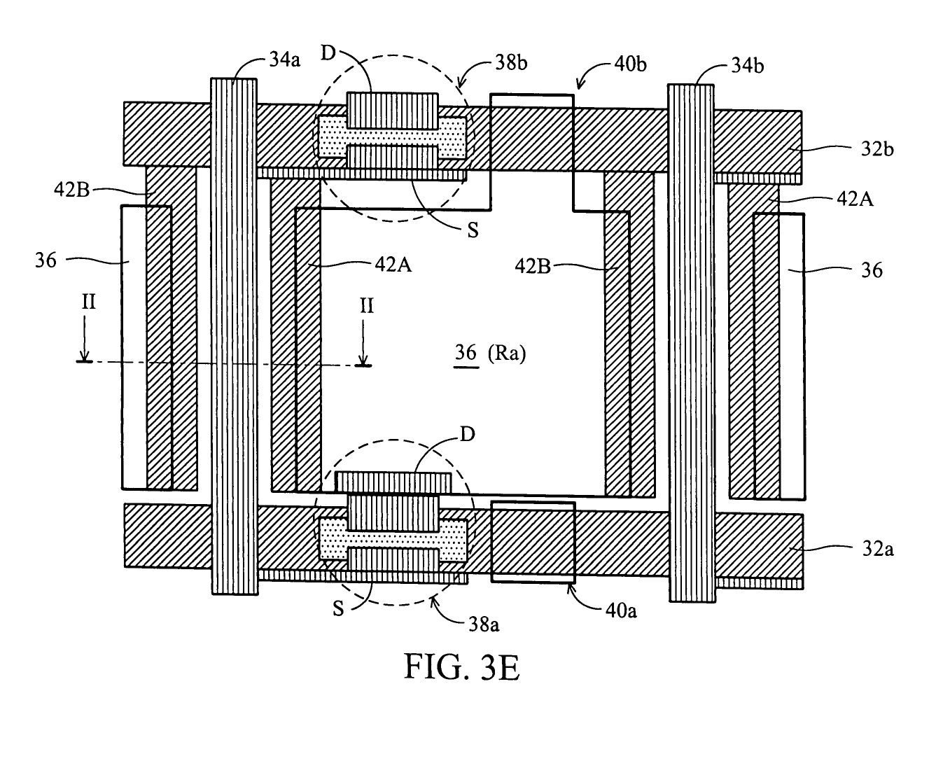

FIG. 3A is a plane view showing a pixel area of an LCD device with a high aperture ratio according to the first embodiment of the present invention. In the LCD device, a pixel area Ra comprises a pair of gate lines 32a and 32b, a pair of data lines 34a and 34b, a pixel electrode 36, a switching element 38a, a pair of floating BM shielding layers 42A and 42B and a storage capacitor 40b. Particularly, at least one of the floating BM shielding layers 42A and 42B is connected to one of the gate lines 32a and 32b. The pixel electrode Ra is defined by the pair of transverse-extending gate lines 32a and 32b and the pair of lengthwise-extending data lines 34a and 34b, and the pixel electrode 36 covers most of the pixel area Ra. The switching element 38a is electrically connected to the pixel electrode 36 and the data line 34a. Floating BM shielding layer 42A is parallel to the data lines 34a and adjacent to data line 34a and the periphery of the pixel electrode 36, in which an overlapping portion is formed between floating BM shielding layer 42A and the periphery of the pixel electrode 36. Floating BM shielding layer 42B is parallel to the data lines 34b and adjacent to the data line 34b and the periphery of the pixel electrode 36, in which an overlapping portion is formed between floating BM shielding layer 42B and the periphery of the pixel electrode 36. Particularly, the floating BM shielding layer 42B is connected to the gate line 32b. The storage capacitor 40b is formed on a predetermined area of the gate line 32b in order to increase the transparent area in the pixel area Ra.

The formation of the floating BM shielding layers 42A and 42B is separate from the gate line process. Alternatively, formation of the floating BM shielding layers 42A and 42B are integrated with the gate line process by using the same material layer. The floating BM shielding layers 42A and 42B may have the same width or not.

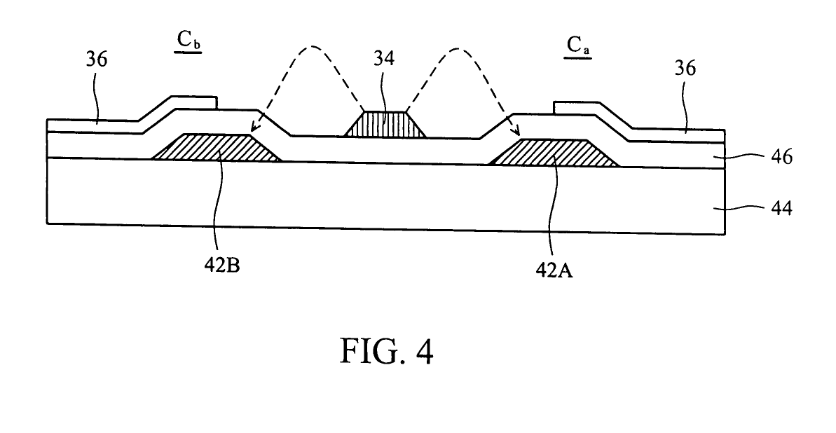

FIG. 3E is a plane view showing a TFT-LCD device with a floating BM shielding layer as a light-shielding element according to the first embodiment of the present invention. FIGS. 3B to 3D are plane views showing a method of forming the electrode array in the TFT-LCD device shown in FIG. 3E. FIG. 4 is a sectional diagram along line II-II shown in FIG. 3E.

In the first embodiment of the present invention, a TFT-LCD device which substantially comprises a pixel array and a switching element array is now described. The present invention, however, is not limited to the disclosed embodiment.

As shown in FIG. 3E, the pixel area Ra is defined by a transverse-extending pair of the first gate line 32a and the second gate line 32b and a lengthwise-extending pair of the first data line 34a and the second data line 34b, in which the pixel electrode 36 covers most of the pixel area Ra. The first gate line 32a and the second gate line 32b serve as scanning electrodes, and the first data line 34a and the second data line 34b serve as video signal electrodes. The first TFT 38a is formed on a first predetermined area of the first gate line 32a to serve as a switching element, and a second TFT 38b is formed on a first predetermined area of the second gate line 32b to serve as a switching elements. For each of the TFTs 38a and 38b, the drain electrode D is electrically connected to the pixel electrode 36, and the source electrode S is electrically connected to an extension portion of the data line 34a.

Also, a first storage capacitor 40a is formed on a second predetermined area of the first gate line 32a, and the second capacitor 40b is formed on a second predetermined area of the second gate line 32b. Since the two TFTs 38a and 38b and the two storage capacitors 40a and 40b are formed outside the pixel electrode 36, the pixel area Ra has a larger transparent area.

Moreover, the first floating BM shielding layer 42A is parallel to the first data line 34a in order to shield a first light leakage area between the first data line 34a and the periphery of the pixel electrode 36, and the second floating BM shielding layer 42B is parallel to the second data line 34b in order to shield a second light leakage area between the second data line 34b and the periphery of the pixel electrode 36. Particularly, one end of each floating BM shielding layer 42A and 42B is connected to the second gate line 32b that corresponds to the pixel area Ra. Also, a first overlapping portion is provided between the first floating BM shielding layer 42A and the periphery of the pixel electrode 36, and a second overlapping portion is provided between the second floating BM shielding layer 42B and the periphery of the pixel electrode 36.

A process for manufacturing the electrode array in the TFT-LCD device according to the first embodiment of the present invention is now described with reference to FIGS. 3B˜3E and FIG. 4.

First, as shown in FIG. 3B, using deposition, photolithography, and etching, a first metal layer formed on a glass substrate 44 forms the pattern of gate lines 32a and 32b and floating BM shielding layers 42A and 42B. Floating BM shielding layers 42A and 42B are electrically connected to the second gate line 32b. Each of the gate lines 32a and 32b comprises a predetermined portion 40×which serves as a bottom electrode of the storage capacitors 40a and 40b. Preferably, the first metal layer is Cr, Ta, Ti, Al or Mo.

Then, as shown in FIG. 3C and FIG. 4, a gate insulating layer 46 is deposited on the entire surface of the glass substrate 44, and then processes for forming the TFTs 38a and 38b are performed on a predetermined portion 38×of the gate lines 32a and 32b.

Next, as shown in FIG. 3D, using deposition, photolithography, and etching, a second metal layer formed on the gate insulating layer 46 forms the pattern of data lines 34a and 34b, the source electrodes S of the TFTs 38a and 38b, and the drain electrodes D of the TFTs 38a and 38b. Preferably, the second metal layer is Cr, Ta, Ti, Al or Mo.

Finally, as shown in FIG. 3E and FIG. 4, using deposition, photolithography, and etching, a transparent conductive layer formed on the glass substrate 44 forms the pattern of pixel electrode 36, an upper electrode of the first storage capacitor 40a, and an upper electrode of the second storage capacitor 40b. The pixel electrode 36 is connected to the upper electrode of the second storage capacitor 40b over the predetermined portion 40×of the second gate line 32b.

According to the above-described electrode array, the first floating BM shielding layer 42A and the second floating BM shielding layer 42B can shield the light leakage areas adjacent to the first data line 34a and the second data line 34b, respectively, thus the TFT-LCD device has a higher aperture ratio and superior contrast. Additionally, the first floating BM shielding layer 42A and the second floating BM shielding layer 42B are connected to the second gate line 32b. Thus, the shielding effect provided by floating BM shielding layers 42A and 42B can reduce the coupling effect between the data lines 34a and 34b and the pixel electrode 36. Furthermore, as shown in FIG. 4, a first overlapping portion between the first floating BM shielding layer 42A and the pixel electrode 36 provides a first complementary capacitor Ca, and a second overlapping portion between the second floating BM shielding layer 42B and the pixel electrode 36 provides a second complementary capacitor Cb, resulting in expanded capacitance in the pixel area Ra. In another modification, the width of the gate line 32a or 32b can be narrowed to increase the transparent area without losing adequate capacitance compared with a conventional TFT-LCD device because the two complementary capacitors Ca and Cb can compensate for the lost capacitance of the storage capacitors 40a and 40b caused by reducing the active area of the bottom electrodes.

Second Embodiment

For the above-described gate lines 32a and 32b and the data lines 34a and 34b, the wiring patterns may easily disconnect if the regions they pass through during the heat treatments or etching processes are rough, resulting in open or short circuits. As the size and resolution of LCD device continue to increase, large numbers of data lines and gate lines with a narrower line width will be required on the TFT array substrate. The fabricating difficulties will also be increased, resulting in a greater chance of broken wiring patterns. Accordingly, it is desirable to provide a repair method that allows the LCD to operate despite broken wiring. In the second embodiment of the present invention, the above-described electrode array is modified to provide an operative path for repairing opened gate lines.

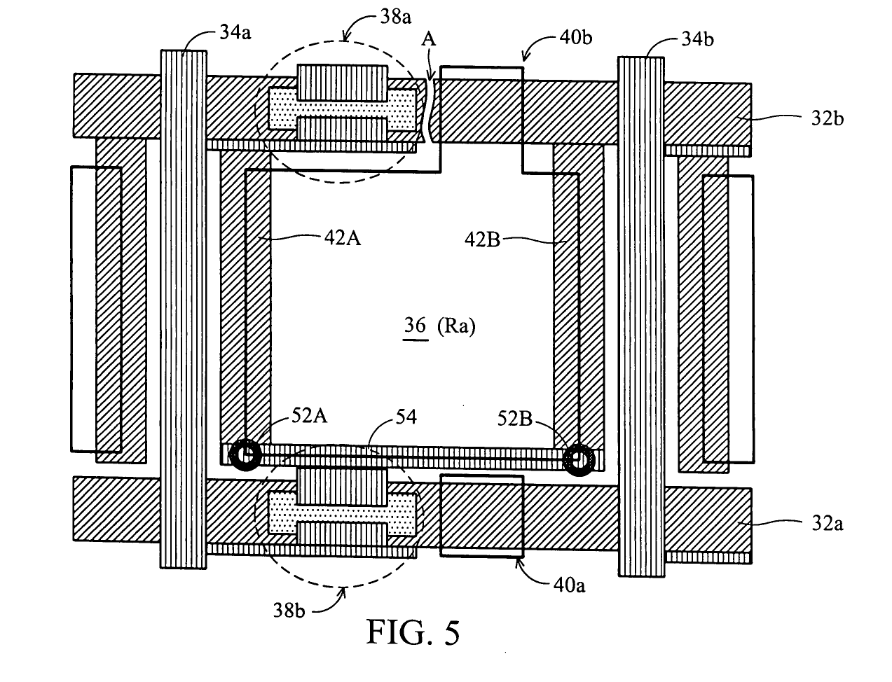

FIG. 5 is a plane view showing an electrode array for repairing gate lines according to the second embodiment of the present invention. The electrode array of the pixel area Ra in the second embodiment is substantially similar to that of the first embodiment, with the similar portions omitted herein. With regard to dissimilar portions, the second metal layer that forms the pattern of data lines 34a and 34b, source electrode S, and drain electrode D are additionally patterned as a repair line 54. Preferably, the repair line 54 traverses a spacing between the first floating BM shielding layer 42A and the second floating BM shielding layer 42B. A first overlapping portion between the repair line 54 and the first floating BM shielding layer 42A is provided as a first repair point 52A, and a second overlapping portion between the repair line 54 and the second floating BM shielding layer 42B is provided as a second repair point 52B.

For example, when the second gate line 32b is broken to form an opening portion A, the repair points 52A and 52B can be electrically connected to floating BM shielding layers 42A and 42B, respectively, by using laser fusing or other techniques. Thus, a path through the floating BM shielding layers 42A and 42B and the repair line 54 can replace the opening portion A of the gate line 32b.

Third Embodiment

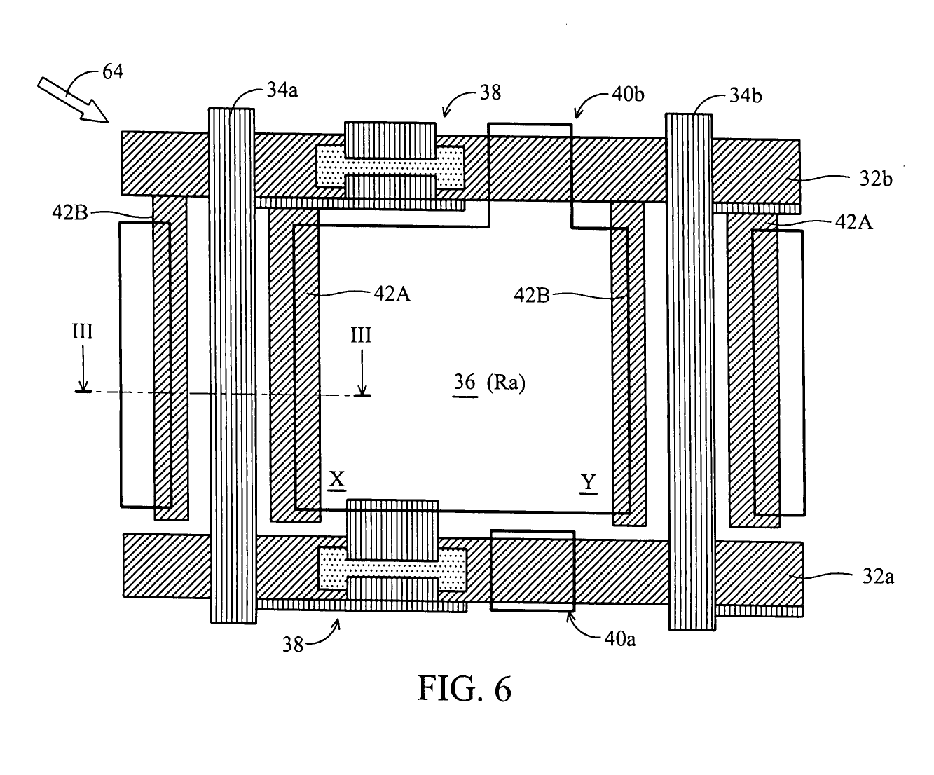

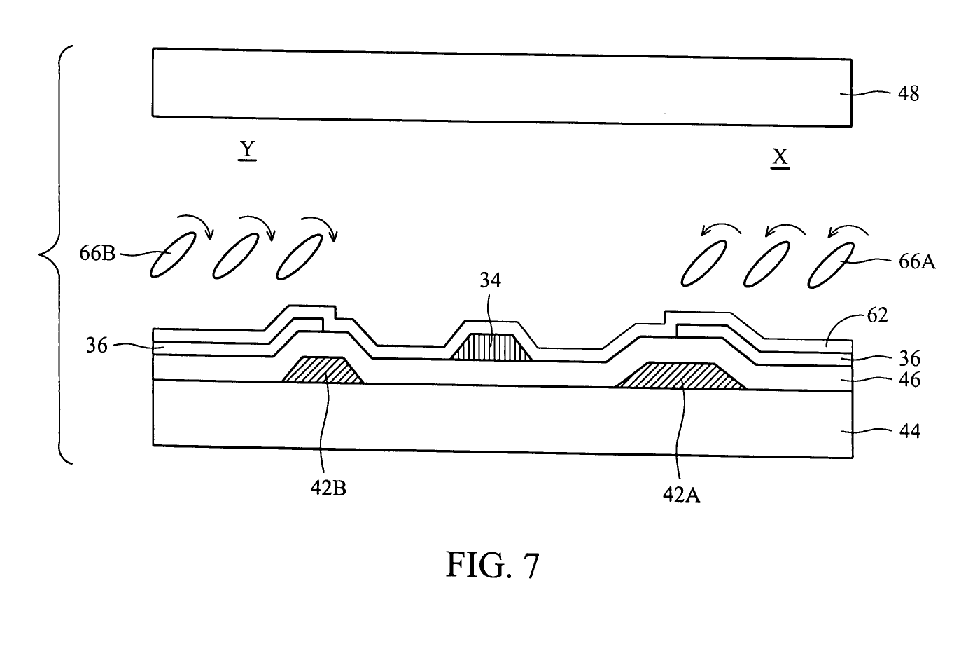

FIG. 6 is a plane view showing a TFT-LCD device with a floating BM shielding layer functioning as a light-shielding element according to the third embodiment of the present invention. FIG. 7 is a sectional diagram along line III-III shown in FIG. 6 in order to show LC molecule orientations. The electrode array of the pixel area Ra in the third embodiment is substantially similar to that of the first embodiment, with the similar portions omitted herein. With regard to dissimilar portions, the two floating BM shielding layers have asymmetrical widths. Preferably, the first floating BM shielding layer 42A adjacent to an LC reverse region has a larger width, and the second floating BM shielding layer 42B adjacent to an LC non-reverse region has a smaller width.

As shown in FIG. 7, after completing the electrode array, an LC alignment layer 62 is formed on the glass substrate 44, and an angle between the rubbing direction of the LC alignment layer 62 and the data line 34 is 40˜50 degrees. Also, by providing another glass substrate 48, which serves as a color filter substrate, an LC layer is filled into a space between the two glass substrates 44 and 48. This completes a TFT-LCD cell.

For example, when the rubbing direction shown by an arrow 64 in FIG. 6 is 45 degrees, an angle between a long axis of all LC molecules 66 and the LC alignment layer 62 is 45 degrees before an extra voltage is applied to the TFT-LCD device. After an extra voltage is applied to the TFT-LCD device, a first LC molecule 66A adjacent to the first floating BM shielding layer 42A rotates in a counterclockwise direction toward the first data line 34a, resulting in an LC reverse region X. In the meantime, a second LC molecule 66B adjacent to the second floating BM shielding layer 42B rotates in a clockwise direction toward the second data line 34b, resulting in an LC non-reverse region Y. Accordingly, in order to effectively reduce light leakage, the first floating BM shielding layer 42A adjacent to the LC reverse region X can be modified as a wider layer, and the second floating BM shielding layer 42B adjacent to the LC non-reverse region Y can be modified as a narrower layer.

In addition, the two floating BM shielding layers 42A and 42B are connected to the second gate line 32b. Thus, the repair line 54 and the method for repairing a broken gate line described in the second embodiment can be applied to the third embodiment.

Fourth Embodiment

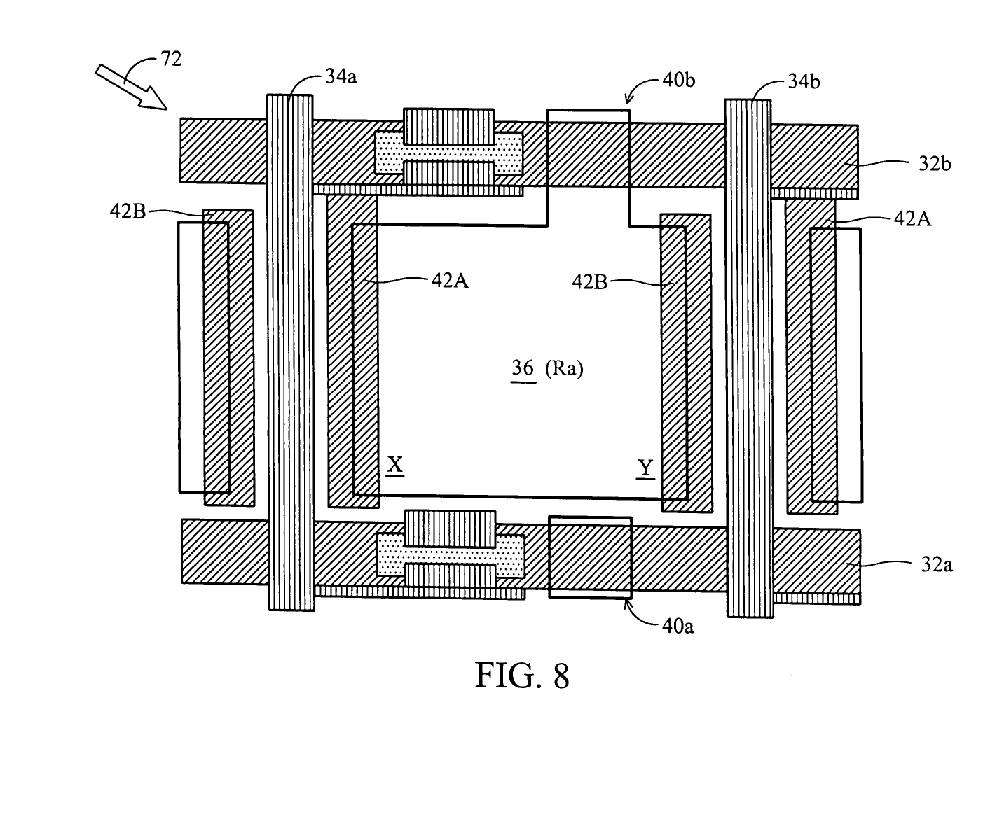

FIG. 8 is a plane view showing a TFT-LCD device with a floating BM shielding layer functioning as a light-shielding element according to the fourth embodiment of the present invention. The electrode array of the pixel area Ra in the fourth embodiment is substantially similar to that of the first embodiment, with the similar portions omitted herein. With regard to dissimilar portions, the two floating BM shielding layers 42A and 42B have asymmetrical connections to the second gate line 32b. Preferably, the first floating BM shielding layer 42A adjacent to an LC reverse region X is electrically connected to the second gate line 32b, and the second floating BM shielding layer 42B adjacent to an LC non-reverse region Y is not electrically connected to the second gate line 32b.

For example, when the rubbing direction shown by an arrow 72 in FIG. 8 is 45 degrees, an angle between a long axis of all LC molecules 66 and the LC alignment layer 62 is 45 degrees before an extra voltage is applied to the TFT-LCD device. After an extra voltage is applied to the TFT-LCD device, LC molecules adjacent to the first floating BM shielding layer 42A rotate in a counterclockwise direction, resulting in an LC reverse region X. In the meantime, LC molecules adjacent to the second floating BM shielding layer 42B rotate in a clockwise direction, resulting in an LC non-reverse region Y. Accordingly, in order to effectively reduce light leakage, the first floating BM shielding layer 42A adjacent to the LC reverse region X must be electrically connected to the second gate line 32b, and the second floating BM shielding layer 42B adjacent to the LC non-reverse region Y may be selectively connected to the second gate line 32b.

The width of the second floating BM shielding layer 42B adjacent to the LC non-reverse region Y may be selectively narrower than the width of the first floating BM shielding layer 42A or not. Preferably, the two floating BM shielding layers 42A and 42B have an identical width in the third embodiment.

According to the above-described embodiments, the present invention has the following advantages. First, the electrode array design for the TFT-LCD device can provide a higher aperture ratio. Second, the overlapping portion between the floating BM shielding layer and the periphery of the pixel electrode can serve as a complementary capacitor. Third, the overlapping portion between the gate line and the extension portion of the pixel electrode can serve as a storage capacitor. Fourth, the connection between the floating BM shielding layer and the gate line can reduce the coupling effect between the data line and the pixel electrode. Fifth, the repair line across two ends of the two floating BM shielding layers, respectively, can provide an operative path for repairing a broken gate line. Sixth, the first metal layer is used to pattern the gate line and the floating BM shielding layer in the same process. Thus, simplifying the procedure and reducing process cost. Seventh, depending on the LC reverse region and the LC non-reverse region, the first floating BM shielding layer and the second floating BM shielding layer can be modified to have asymmetrical widths and asymmetrical connections to the gate line.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A liquid crystal display including a plurality of pixel areas, each pixel area comprising:
a pixel area defined by a first transverse-extending gate line, a second transverse-extending gate line, a first lengthwise-extending data line, and a second lengthwise-extending data line;
a pixel electrode formed overlying the pixel area;
a switching element electrically connected to the pixel electrode; and
a first shielding layer electrically connected to the first gate line, wherein the first shielding layer is parallel to the first data line and adjacent to the first data line.

2. The liquid crystal display as claimed in claim 1, wherein the first shielding layer overlaps the periphery of the pixel electrode to provide a first overlapping portion.

3. The liquid crystal display as claimed in claim 1, further comprising a second shielding layer parallel to the second data line and adjacent to the second data line.

4. The liquid crystal display as claimed in claim 3, wherein the second shielding layer is not electrically connected to the first gate line.

5. The liquid crystal display as claimed in claim 3, wherein a spacing between the first data line and the periphery of the pixel electrode is a liquid crystal reverse region, and a spacing between the second data line and the periphery of the pixel electrode is a liquid crystal non-reverse region.

6. The liquid crystal display as claimed in claim 5, wherein the width of the first shielding layer adjacent to the liquid crystal reverse region is larger than the width of the second shielding layer adjacent to the liquid crystal non-reverse region.

7. The liquid crystal display as claimed in claim 3, further comprising a repair line situated across the first shielding layer and the second shielding layer,
wherein (i) the repair line partially overlaps the first shielding layer in order to provide a first repair point, and (ii) the repair line partially overlaps the second shielding layer to provide a second repair point.

8. A liquid crystal display, comprising:
a first substrate;
a second substrate;
a liquid crystal layer formed in a space between the first substrate and the second substrate;
a pixel area array formed overlying the first substrate and defined by a plurality of transverse-extending gate lines and a plurality of lengthwise-extending data lines;
a pixel electrode array including a plurality of pixel electrodes formed overlying the corresponding pixel areas;
a switching element array including a plurality of switching elements, wherein each switching element is connected to the corresponding pixel electrode and the corresponding data line; and
a first shielding layer array including a plurality of first shielding layers formed in the corresponding pixel areas, wherein each first shielding layer (i) is electrically connected to the corresponding gate line, (ii) extends parallel to the data line, and (iii) is adjacent to one side of the corresponding data line.

9. The liquid crystal display as claimed in claim 8, further comprising a second shielding layer array including a plurality of second shielding layers, wherein each second shielding layer (i) is formed overlying the corresponding pixel area, (ii) extends parallel to the data line, and (iii) is adjacent to another side of the corresponding data line.

10. The liquid crystal display as claimed in claim 9, wherein the first shielding layer and the second shielding layer have an identical width.

11. The liquid crystal display as claimed in claim 8, wherein the switching element is a thin film transistor.

12. The liquid crystal display as claimed in claim 8, wherein each first shielding layer partially overlaps the periphery of the corresponding pixel electrode to form a first overlapping portion which serves as a first complementary capacitor.

13. The liquid crystal display as claimed in claim 9, further comprising a repair line across the first shielding layer and the second shielding layer within each pixel area, wherein (i) the repair line partially overlaps the first shielding layer to provide a first repair point, and (ii) the repair line partially overlaps the second shielding layer to provide a second repair point.

14. A liquid crystal display including at least a semiconductor structure which includes at least a pixel area array, each pixel area comprising:
a first metal layer serving as a first transverse-extending gate line, a second transverse-extending gate line, a first lengthwise-extending shielding layer, and a bottom electrode of a storage capacitor, wherein the first shielding layer is (i) disposed between the first gate line and the second gate line and (ii) electrically connected to the first gate line;
an insulating layer covering the first metal layer;
a second metal layer serving as a first lengthwise-extending data line, a second lengthwise-extending data line which defines the pixel area, and a source/drain electrode of a thin film transistor; and
a transparent conductive layer covering the pixel electrode in order to serve as a pixel electrode and an upper electrode of the storage capacitor.

15. The liquid crystal display as claimed in claim 14, wherein the first metal layer further serves as a second shielding layer disposed between the first gate line and the second gate line.

16. The liquid crystal display as claimed in claim 15, wherein the second shielding layer is electrically connected to the first gate line.

17. The liquid crystal display as claimed in claim 15, further comprising a repair line across the first shielding layer and the second shielding layer within each pixel area, wherein (i) the repair line partially overlaps the first shielding layer to provide a first repair point, and (ii) the repair line partially overlaps the second shielding layer to provide a second repair point.

18. The liquid crystal display as claimed in claim 15, further comprising an alignment layer formed over each pixel area,
wherein, when an angle between a rubbing direction of the alignment layer and the data line is 40 to 50 degrees, a spacing between the first data line and the periphery of the pixel electrode is a liquid crystal reverse region, and a spacing between the second data line and the periphery of the pixel electrode is a liquid crystal non-reverse region; and
wherein the width of the first shielding layer adjacent to the liquid crystal reverse region is larger than the width of the second shielding layer adjacent to the liquid crystal non-reverse region.

19. The liquid crystal display as claimed in claim 15, wherein the first shielding layer partially overlaps the periphery of the pixel electrode to form a first complementary capacitor, and the second shielding layer partially overlaps the periphery of the pixel electrode to form a second complementary capacitor.

20. The liquid crystal display as claimed in claim 14, wherein the first metal layer and the second metal layer are made of Cr, Ta, Ti, Al or Mo.
